(19) United States
(12) Patent Application Publication
(10) Pub. No.: US 2018/0082139 A1
(43) Pub. Date: Mar. 22, 2018

(54) Efficiently Building Nutrition Intake History from Images of Receipts

(71) Applicant: WhatUBuy LLC, Farmington, CT (US)

(72) Inventors: Dongsheng Li, Farmington, CT (US); Charles Ronald Musick, JR., Farmington, CT (US)

(73) Assignee: WhatUBuy LLC, Farmington, CT (US)

(21) Appl. No.: 15/272,433

(22) Filed: Sep. 22, 2016

(51) Int. Cl. G06K 9/18; G06N 99/00; G06K 9/46; G06F 17/30; G06Q 10/08; G09B 19/00

(52) U.S. Cl. CPC G06K 9/18; G06N 99/005; G06K 9/4604; G09B 19/0092; G06F 17/30563; G06Q 10/087; G06F 17/30253

(57) ABSTRACT

This invention provides an efficient and feasible method, system and computer program for retrieving total nutrition facts from purchase transaction information including receipt images and other complementary data. The said facts are used to build up the nutrition intake history, provide nutrition intake reports and customized nutrition suggestions based on the users' personal health related information and nutrition intake data. The method initiates from receiving information on a transaction in the format of an image of a receipt, or other itemized input. If the input is a receipt image, an automatic process including image processing, machine learning and text extraction is applied to retrieve the purchased items and quantity, from which total nutrition facts are derived using the nutrition information of each purchased item found in public, or in private and undisclosed vendor and distributor databases that are reconstructed in a preferred embodiment. Other inputs, such as manual food item entry or bar code scanning, are used occasionally as a backup. This method streamlines nutrition intake recording, making nutrition monitoring efficient and feasible. Combined with machine learning and pattern recognition, the nutrient intake history of families and individuals is used to provide nutrient insufficiency or obesity forecasts. It will be a critical tool to the community in fighting obesity and other food intake related diseases.

### REFERENCES CITED

French S A, Shimotsu S T, Wall M, Gerlach A F. Capturing the spectrum of household food and beverage purchasing behavior: a review. Journal of the American Medical Association. 2008; 108:2051-2058.
Flegal K M, Carroll M D, Kit B K, Ogden C L. Prevalence of obesity and trends in the distribution of body mass index among US adults, 1999-2010. Journal of the American Medical Association. 2012; 307(5):491-97.
Ogden C L, Carroll M D, Kit B K, Flegal K M. Prevalence of obesity and trends in body mass index among US children and adolescents, 1999-2010. Journal of the American Medical Association. 2012; 307(5):483-90.
Paul J, Rana J. Emerald Article: Consumer behavior and purchase intention for organic food. Journal of Consumer Marketing. 2012; 29(6): 412-422
Bassett M T, et. al. Purchasing behavior and calorie information at fast-food chains in New York City. Am J Public Health. 2008; 98:1457-1459. doi:10.2105/AJPH.2008.135020
Mozaffarian D, et. al. Executive summary: heart disease and stroke statistics—2015 update: a report from the American Heart Association. Circulation. 2015; 131:434-441
Dietary reference intakes for water, potassium, sodium chloride, and sulfate. Institute of Medicine. National Academies Press; 2004
Bellows A C, Onyango B, Diamond A, Hallman W K. Understanding consumer interest in organics: production values vs purchasing behavior. Journal of Agricultural & Food Industrial Organization, 2008, Vol. 6, Article 2.
Blitstein J L, Evan W D. Use of nutrition facts panels among adults who make household food purchasing decisions. J Nutr Educ Behav. 2006; 38:360-364
Franklin B, et. al. Exploring mediators of food insecurity and obesity: a review of recent literature. J Community Health. 2012; 37(1): 253-264. doi:10.1007/s10900-011-9420-4.
WHO. Guideline: Sodium intake for adults and children. Geneva, World Health Organization (WHO), 2012.
https://ndb.nal.usda.gov/ndb/search/list
www.atipfoundation.com
http://www.healthywomen.org/condition/nutrition
https://health.gov/dietaryguidelines

### BACKGROUND OF THE INVENTION

### Field of the Invention

The present invention generally relates to the broad area of nutrition intake data collection protocol, risk based decision making, computing, specifically ETL (extract, transform, load), image processing and machine learning. This invention relates to a method for retrieving total nutrition facts efficiently by automatically recovering and allocating such information from grocery receipts and other complementary transaction information. In some embodiments, crowdsourced marketplaces are used to reconstruct undisclosed vendor databases to enable matching receipt information with food nutrition data. In some embodiments, machine learning is applied to automatically update models for allocating food between household members, and models for allocating food between storage, consumption and waste.

### Background

Tracking and monitoring nutrition intake history is critical in the fight against obesity, cardiovascular disease, and other diet-related problems. According to an NIH examination survey in 2010, more than ⅔ of adults are overweight and 34.9% or 78.6 million U.S. adults are obese. In the case of children and adolescents between ages 6 to 19, ⅓ are overweight and ⅙ are obese. It is well known that overweight and obesity are risk factors for diabetes, heart disease, high blood pressure, and other health problems. When considering historical data, the trend is even more worrisome. Since the early 1960s, the prevalence of obesity among adults has more than doubled, increasing from 13.4 to 35.7 percent. Of the many factors attributed to obesity, imbalanced diet and high calorie food are considered the major causes. It is important for the population to become aware and be vigilant on caloric intake.

It is equally important to keep track of the intake of different types of fat, as well as vitamins and minerals such as sodium, potassium, calcium and so on. According to a report from American Heart Association, ⅓ of the adult population in the US has high blood pressure, which may induce heart disease and stroke, the nation's first and fourth leading causes of death. Research shows a strong dose-dependent relationship between consuming too much salt and raised levels of blood pressure. Currently, there are no means available for people to keep track of nutrition intake. Family nutrition intake is typically dependent on tradition, community and environment. Advertisements or misguided voucher programs can easily steer a community down an unhelpful or even unhealthy path, affecting all members in a household. Providing tools to monitor nutrition intake histories will be critical to help steer the household, and the community back to right track. The tools will provide motivation for members of the community to take actions based on smart informed food choices.

The gap identified here is a lack of feasible methods to collect complete full-spectrum nutrition intake history. Current available data collection protocols are either incomplete, or focused on a narrow aspect of nutrition, such as one kind of nutrient, or a small temporal range. Current protocols are also impractical to achieve for a common user instead of a full time dedicated scientific researcher. Two major advances needed to make widespread nutrition intake measurement and reporting a reality are: (1) a substantially automatic means of acquiring accurate item-level food information for households; and (2) a substantially automatic means of identifying which portion of household food items is consumed by which household members.

A first step to address the weight gain trend described above is to build up a method to quickly and easily assemble nutrition intake information, and provide easy-to-consume reports on the same to the general population. An informed population will at least have a chance to make better decisions with respect to their own personal food intake.

This invention provides an efficient and feasible process for nutrition intake data collection and interpretation. The completeness of the data collected with these methods is not just a key step for the consumer, but it will also help in nutrition-related researcher. In particular, it will help researchers create more dependable surveys related to nutrition intake and purchase activities, taking into consideration of relationships between purchase behavior and other factors including income, age, gender, family size, community, commercialism, etc. Current nutrition survey methods provide some qualitative information about the food and beverages purchased, but are far from being able to provide quantitative data. They are unable to provide the precise temporal measure of purchasing patterns and variability over time for key food categories needed to quantify individual overall dietary quality.

The tools and apps developed based on this invention will be indispensable in fighting obesity, raising early alarms on critical signals in excessive calories, unsaturated fat, mineral/vitamin deficiency or overdose, etc. When utilized by a large population, the data collected will provide deeper and more complete understanding of the complexity of the relationship between obesity and food insecurity (the lack of dependable access to quality nutrition), income, gender, age, marital status, cyclical eating patterns, food favorite structure, etc. They will help the general population make smart purchase decisions and achieve long term nutrition balance goals while not sacrificing the award-type consumer impulse buy.

### RELATED ART

The ability to fulfill this promise is strictly limited by the general population's willingness to spend time and effort to collect their own complete full spectrum nutrition data. For example, measuring the nutrition intake of any individual requires gathering specific item-level information on what that individual eats. Requiring that individual to enter such information manually is neither meaningful nor practical. These by-hand capabilities have existed for years. For example, manually, any consumer can write their food down and look up all related nutrition facts. For example, as implemented in different data collection protocols and practiced in many research-oriented surveys, surveyees write their food down manually or provide their receipts; and surveyors look up all related nutrition facts. For example, in some partially automated procedures, consumers can enter the food they consume in an app like MyPlate Tracker and the app calculates nutrition facts automatically. Unfortunately, even though the personal and social need for this information is clearly significant, the time consuming manual element of entering each item by hand presents a barrier that makes such tools infeasible for the overwhelming majority of the population.

As indicated above, the two major advances needed to make widespread nutrition intake measurement and reporting a reality are: (1) a substantially automatic means of acquiring accurate item-level food information for households; and (2) a substantially automatic means of identifying which portion of household food items is consumed by which household members.

The food purchase and intake profile for a household is multisource and multispectral from all perspectives. For example, recent studies have shown that household nutrient intake from fast food restaurants have increased dramatically over the years. Nevertheless, a significant fraction of household nutrition intake data is represented in the grocery (and other related) receipts of a household. To automatically acquire item-level food data for a household, one must convert the grocery receipts into item-level food data. This has proven to be an exceedingly difficult challenge for those skilled in the art.

The prior art contains many examples of apps (such as Kachi) and websites that require the consumer to enter all information about the food they eat. While highly accurate when the consumer is extremely diligent and devoted, there is nothing automated about the acquisition of data, and as a result, only a tiny fraction of the public engages. No further reference to this type of approach is made herein.

Many grocers track the purchases of their clients through loyalty programs. Their data contains item-level food data, but it is private and not disclosed to the consumer, developer or researcher. Even if large grocers began to share this data, the spectrum of food purchase patterns captured from a single grocer would be so incomplete as to be useless, since a typical household buys food and groceries from multiple vendors. The consumer cannot rely on this source or data now or anytime in the near future.

Receipt collection, annotation, and categorization used in previous federally funded studies have been processed manually. To overcome the challenge in data collection and interpretation, the researchers in the areas of nutrition study and purchasing behavior have utilized sampling methods to accommodate this challenge by selecting only subsets of the data to collect. The approach is not comprehensive enough to be useful to the general population since the samples collected are typically not representative of the full nutrition intake. Additionally, sampling strategies have proven to be very hard to implement for an individual or household for months in a controlled study, let alone years in an uncontrolled setting, in large part because of the time and effort required for manually processing receipts.

The prior art contains many examples of methods that enable scanning receipts, then perform Optical Character Recognition (OCR) to extract text. For example, apps like Wave and Shoeboxed provide storage for a customer's receipt images and OCR data. However, OCR data are not matched with specific products in these apps, so they cannot be used to acquire item-level food data.

Prior art such as that reflected in apps like ibotta and Checkout51 go one step further. They have a list of internal products with rebates, and will attempt to match the OCR data of scanned receipts up with the internal rebate list. This is a far cry from what is needed for the full scope of item-level food data acquisition problem. As one skilled in the art would recognize, the rebate lists, by nature, are predefined, uniform, and small, making the matching problem between items and OCR data much simpler. There may be hundreds of rebates on a list, but there are hundreds of thousands of food items available in grocery stores across North America, making that matching problem significantly more challenging. Furthermore, these apps provide no teachings on how to acquire the food item data in the first place. Such data is private to each grocer and producer, always changing, and not available to the public. Without this full list of food items, it is impossible to retrieve food item data from receipts.

The teachings of the present invention take the innovative step of automating the acquisition of food item data from images of receipts, for substantially all food items in any given market. The only work asked of the consumer is to take an image of their food receipts.

The second major advance needed to make widespread nutrition intake measurement and reporting a reality is to provide a substantially automatic means of identifying which portion of household food items is consumed by which household members.

Acquiring a complete image of an individual's nutrition intake depends on many human factors including purchase behavior, out-of-home consumption, family size and distribution, guest eating, and waste. Grocery receipt data accounts for a significant portion of a typical household's consumption, but also carries with significant distribution challenges among individuals in the same household, and the waste basket. This step of moving from itemized receipt data to individual consumption is a major blocker preventing the accurate measuring and reporting of individual intake. We are unaware of any prior art in this area.

### SUMMARY OF THE INVENTION

This section summarizes some aspects of the present invention and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In this present disclosure, a “household” represents one or more individuals (“household members”) whose activities in food purchase and consumption are shared with each other. This includes, for example, family members that cohabitate, fraternity house members, roommates, and so on. The common feature for a household as used herein is the members share the food purchase activities.

Generally speaking, the present invention pertains to computing a household member's nutrition intake by acquiring images of the household member's household grocery receipts; processing the images to match purchased food therein against a reconstructed vendor database; and computing the household member's nutrition intake for a period of time.

According to one aspect of the present invention, the invention is a method for text extraction from one image of a receipt acquired by a household member. The method comprises:
processing the image with two or more different processing techniques to generate two or more different processed images;
performing text extraction on the two or more processed images; and
combining the text extraction on the two or more processed image to provide a supervised balanced text extraction for the original input image.

According to another aspect of the present invention, the invention is a method for reconstructing an undisclosed database from partial and incorrect views. The method comprises:
posting snippet jobs for the undisclosed database in response to a relative sampling rate to a crowdsourced marketplace, with the expectation that a portion of the jobs will be accepted by a worker who works on the portion of the jobs to create completed snippets;
assembling the completed snippets in response to a worker accuracy model; and updating the undisclosed database.

According to yet another embodiment, this invention is a method for maintaining multiple worldviews of a food assignment model for a household. The method comprises:
storing a first food assignment model with food allocations consistent with a first household member's manual revisions, and a second food assignment model with food allocations consistent with a second household member's manual revisions;
presenting household food assignments to the first and the second household members as potentially conflicting consumption percentages for each food item represented in a grocery receipt; and
updating the first food assignment model responsive to manual revisions to the food consumption percentages made by the second household member, while ensuring that the first food assignment model presents food consumption percentages consistent with all manual revisions made by the first household member.

According to yet another embodiment, this invention is a method to create a food waste-save model for a household. The method comprises:
building a market-wide waste-save model by relating typical statistics for shelf-life per food type, to average household food storage space in a given market, to typical household food waste rates per food type; and
instantiating the market-wide waste-save model to the household by using household purchase frequency per food type, then revising the household model with any manual revisions made by a household member.

### BRIEF EXPLANATION OF THE DRAWINGS

FIG. 1 shows a process of creating nutrition intake reports according to an embodiment of the invention.

FIG. 2 shows a process of creating and updating vendor food item data according to an embodiment of the invention.

FIG. 3 shows a flow of processing receipts to generate per-food item nutrition information according to an embodiment of the invention. (item to UPC code to total nutrition facts, service size, how many services in one package, . . . )

FIG. 4 shows a process of building an assignment of nutrition percentages per food item for a household according to an embodiment of the invention.

FIG. 5 shows a process of updating and applying a waste-save model according to an embodiment of the invention.

FIG. 6 shows a block diagram producing nutrition intake reports and nutrition management plans according to an embodiment of the invention.

FIG. 7 shows an exemplary traffic signal chart of nutrition intake report for a three member family according to an embodiment of the invention.

FIG. 8 shows an exemplary summary pie chart of nutrition intake report for a three member family according to an embodiment of the invention.

FIG. 9 shows an exemplary speedometer chart of nutrition intake report for an individual during a specified time range according to an embodiment of the invention.

FIG. 10 shows an exemplary dot line plot of nutrition intake history for individuals during a one week time range according to an embodiment of the invention.

FIG. 11 shows an exemplary dot line plot of nutrition intake history for individuals during a one year time range according to an embodiment of the invention.

### DETAILED DESCRIPTION OF EMBODIMENTS

The detailed description of the invention is presented largely in terms of procedures, steps, logic blocks, processing and other symbolic representations that directly or indirectly resemble the operations of data processing devices. These process descriptions and representations are typically used by those skilled in the art to most effectively convey the substance of their work to others skilled in the art.

Numerous specific details are set forth in order to provide a thorough understanding of the present invention. However, it will become obvious to those skilled in the art that the invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

### DETAILED DESCRIPTION OF THE EMBODIMENTS

The present invention pertains to generating an accurate and complete report of nutrition intake for all members of a household, based in part on data derived from images of receipts that a member of the household takes after purchasing food. The preferred embodiments described herein are part of a consumer app called WhatUBuy, designed and developed specifically to address this task.

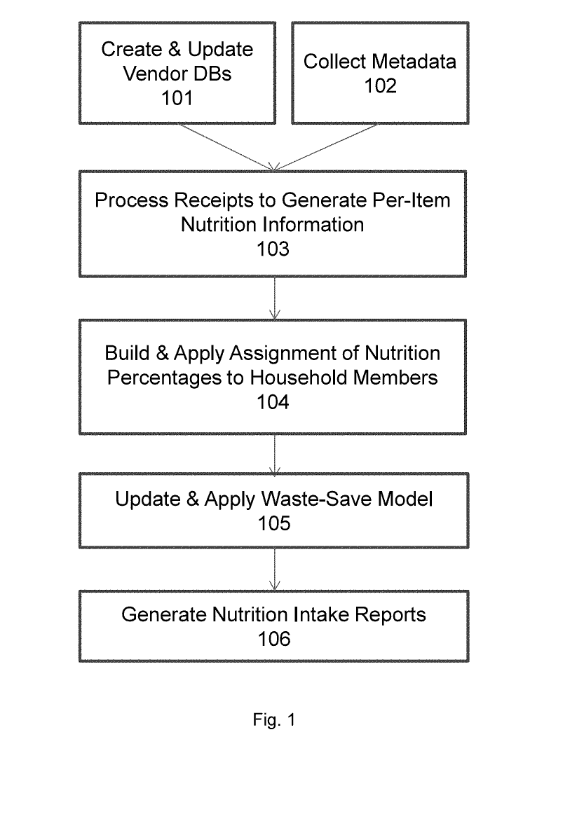

FIG. 1 shows an embodiment of the invention in which a nutrition intake report is updated for every household member once an image of, for example, a grocery receipt, is input. The step of creating the vendor databases 101 is crucial to this embodiment. For example, the data will include nutrition information for every food item sold by Walmart. As explained in the Background Section, there is no such data available to consumers or developers today. The vendor databases created in 101 contain at least the following data for the top one hundred grocers in North America: food item name, number of servings per item, total nutrition facts per serving, and Universal Product Code UPC code. For the case where the food item is not pre-packaged, for example loose-leaf spinach, information on servings and UPC may be missing. In this case, the food item retrieved from receipts is linked with nutrition facts from a public nutrition database. Such databases include USDA National Nutrient Database for Standard Reference, USDA Branded Food Products Database, and USDA Food Composition Databases, etc.

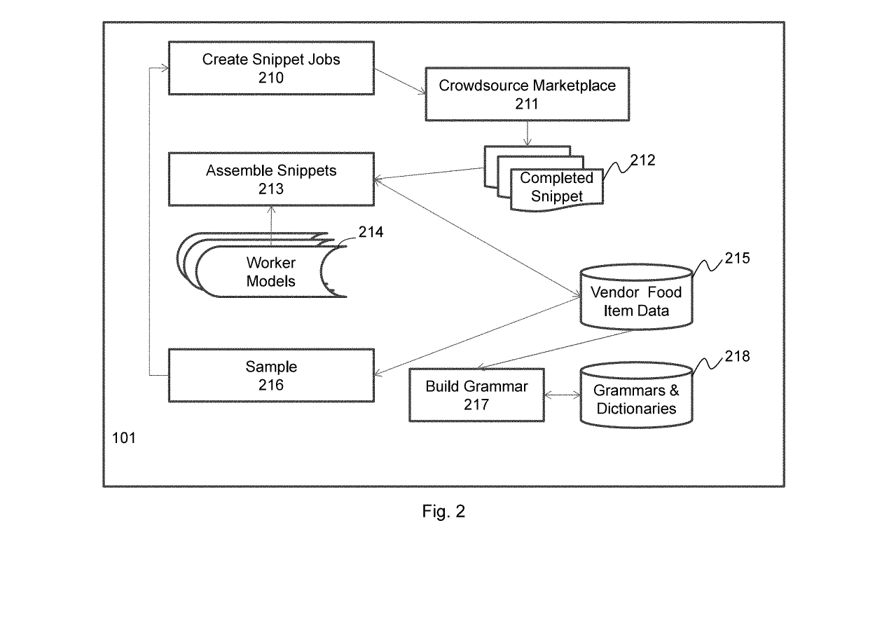

The vendor data in 101 is built by collating information from hundreds of thousands of partial and inaccurate snippets of information, each of which may represent the limited view a single consumer may have of a single vendor's catalog as the result of a single shopping trip. Details on collection, correction, and construction are provided below in the description for FIG. 2. The process in 101 is not synchronized with the household member's shopping or use of the invention. The process in 101 is ongoing in the background, since the food items available from a given vendor are dynamic.

Note that equating receipts to grocery receipts is exemplary only; this invention will work for any vendor receipts for which there is relevant data in the vendor/provider DBs constructed in 101. For example, fast food providers with a limited number of food items, such as McDonald's or Burger King, are particularly easy to incorporate. Similarly, the invention is not limited in intent or implementation to just the top one hundred grocers in North America, but may be applied more broadly in any market.

Another category of input data to pass into image process is collected in process 102, including all metadata and other information, as well as commodity image if necessary. Metadata contains user information (family components, age, health condition, etc.), purchase locations and time, etc.

The process in 103 has access to the vendor DBs constructed in 101. Starting with a receipt for groceries from a household member, one or more images of the receipt is processed in 103 to extract text data for each purchased food item contained in the receipt. The text data is matched up against items in the reconstructed vendor DBs, in order to extract the nutrition data associated with the items that are on the receipt. Without access to vendor DBs created in 101, the process described in 103 simply cannot work. The output of 103 is nutrition information for each food item represented on the receipt. The nutrition information contains everything typically present on a food label on any food item that can be purchased in North America.

The process in 104 converts the nutrition information per-food item provided in 103, to accurate nutrition information for each member of a household. For example, for a food item like a jar of peanut butter, the assignment might be 50% to each of the two children in the household if the kids eat roughly the same amount and the parents eat none. For example, for a food item like a bag of chips, the assignment might be 100% for dad, since he is the only one that consumes them.

The process in 105 accounts for food that is thrown out in every household, and food that is consumed at different rates. A waste-save model is updated and applied to every assigned food item from 104. In the example above, the jar of peanut butter may be assigned a timeframe of 1 month for consumption, based on typical purchase frequency, while the bag of chips may be consumed over a timeframe of 2 days. Continuing the example, a bag of spinach split evenly between members of the household may be assigned a 50% consumption in 6 days, and 50% waste based on the typical shelf life or known expiration date of such a food item.

The process in 106 is primarily a reporting process. Nutrition intake reports and related products are generated for each household member in 106, over a specified time interval such as a day or a week, making use of household metadata collected in 102.

FIG. 2 shows another embodiment of this invention detailing the process of creating the vendor DBs in 101.

As described earlier, vendors generally do not provide an electronic catalogue of the food products they sell. Such data is tied to their competitiveness with other grocers, changes all the time, and may differ from location to location. Furthermore, they typically do not store the nutrition information per food item. This invention requires such per-food item nutrition information in order to generate nutrition intake reports for household members. Those skilled in the art would recognize from the description above that the required data, where it exists, exists in thousands of small unintegrated pieces spread throughout hundreds of private undisclosed vendor databases all with different schema and dictionaries. FIG. 2 creates such data, to our knowledge for the first time.

The embodiment described in FIG. 2 describes an approach to reconstructing and maintaining many databases from hundreds of thousands of partial and often incorrect views of that data. In this embodiment, there may be, for example, 100 grocers in a given market, each of which with hundreds to thousands of food items being sold. This embodiment utilizes crowdsourced marketplaces to acquire said views of the data, for example at sites like Amazon's Mechanical Turk (https://www.mturk.com/mturk/welcome). These partial and often inaccurate views are requested and assembled to create reconstructed vendor databases.

The process in 210 accepts a list of prioritized snippet jobs from 216 (described below), creates some portion of those snippet jobs, and then posts them to the crowdsourced marketplace 211. There are many different types of possible snippet jobs that would all serve a similar purpose. The main criteria for the jobs are the following: easy to understand, fast to carry out, and feasible to deliver a useful view of a vendor's data.

For example, a snippet job may be “Enter the nutrition panel information for “Stop&Shop: Firm Tofu”. For example, a snippet job may be “Upload an image of a receipt from grocery shopping at Krogers”. For example, a snippet job may be “Enter the food item descriptions, weights and price for each item on this receipt”. There are many ways to characterize a useful task. These examples are not intended to limit the scope of this embodiment.

The completed snippets 212 are the solutions to the snippet jobs posted in 210. From the example above, a completed snippet might be “Firm Tofu: calories 100, Servings 2, Protein 3%, Vitamin A 0%”. Each completed snippet is signed by attaching information that helps identify the worker that carried out the work.

The assembly procedure in 213 combines all the completed snippets 212 to form a best model of the vendor databases currently in the system, which is then used as the reconstructed DB. One significant challenge in building a best model of the vendor DBs is in properly processing incorrect completed snippets. One approach would be to oversample every item in every vendor DB several times over, then vote on the results. This approach would be very costly, since every snippet job costs money to carry out. Furthermore, the results would suffer significant inaccuracies. For typical error rates for individual workers, chances of recognizing and agreeing upon a correct completed snippet are poor. It does not help having three completed snippets for one snippet job if none of them agrees and there is no other information or criteria to help judge. Finally, simply oversampling by some factor provides no teachings on how to determine when most or all the items available from a vendor have been seen.

This embodiment solves the challenge above by treating each worker as a random variable. More precisely, the process in 213 models the accuracy of every worker, storing the models in 214. The worker accuracy models 214 enable this embodiment to oversample each datum in the snippet jobs to achieve probably approximately correct (PAC) answers.

For example, continuing the example above, say the current snippet job is to collect nutrition panel information for Firm Tofu from Stop&Shop. Worker_1355 has provided a completed snippet for the task. The current model of Worker_1355 reports his accuracy as a beta distribution B(24, 2), or, roughly, 92.3±5.0%. The goal may be to reach 97.0±2.0%. In this case, the snippet job may be sent out again to the marketplace 211 to gather another completed snippet to help confirm or deny the result from Worker_1355. The model for the accuracy of Worker_1355 is updated based on the degree of match of that second completed snippet.

The assembly process in 213 receives a completed snippet 212 (for exposition purposes, processing of just one completed snippet is described here, but clearly this process runs equally well as a batch process). Assembly then converts the completed snippet into a tuple of <vendor, food-item, support>. Assembly then retrieves the existing tuple from the current reconstructed vendor databases in 215 if the tuple exists, and inserts it if not. The support for the data is updated <date, worker record, summary beta distribution>. Finally, if assembly determines, based on support dates and covered information, that the completed snippet being processed is an oversample, then assembly will update the relevant worker models in 214. If the old and new snippets information agree, then both worker models have their accuracies boosted. If they differ, then both worker models have their accuracies slightly decreased. The exact means of the model updates are not relevant to this embodiment, since many approaches would work well. In both cases, the support for the snippet data is adjusted as though the workers themselves were providing independent assessments of the same underlying snippet data, and so their beta distributions are combined.

For example, if the tuple from a completed snippet contains nutrition panel information for “Stop&Shop: Firm Tofu”, the related entry in the vendor DB in 215 would be updated. The support for a new entry is the dates, list of workers, their respective beta distributions, and the current cumulative estimate of the correctness of that entry.

The sample process 216 checks the state of the current support for all data elements of all vendor data in 215, and issues requests for new snippet jobs to 210 if the data is judged old, incomplete, or not accurate enough. Since vendor data has high turnover rate, the sample process is performed frequently, or continuously.

When requesting new snippet jobs from 210, the sample process 216 sets the priority of the requests to be inversely related to the support estimates for each chunk of snippet data. So the snippet jobs for a chunk of data with a low PAC score may be selected randomly for re-issuance at a rate of several times higher than those jobs with high PAC scores. Note that even if the current estimate of a chunk of data is perfect, 100% accurate, there will always be a chance to re-issue their jobs. Worker performance is non-stochastic, vendor data is short-lived, and so baseline resample probability is a means of detecting a change and adjusting relative sampling rates up as needed. The precise resampling and prioritization formulas are not specifically recorded for this embodiment, since many choices will work equally well. A good choice depends heavily on the size of the budget, number of vendors and items per vendor.

The sample process 216 also estimates the completeness, or gap percentage of a given vendor DB, and prioritizes more job requests for vendors that are more incomplete than others. The gap percentage is estimated by looking at the percentage of new entries over a given period, like within the last month. As vendor coverage increases, that percentage will tend to fall. In this embodiment, the request priority falls off linearly from the maximum reached when the percentage of new items is five percent or more, to when the new item percentage is a minimum of one percent, but there are many choices within the scope of this invention.

Vendor data in 215 is input to a build grammar process 217 that creates a simple grammar and dictionary 218 for each vendor DB. The grammar and dictionary are used in subsequent embodiments to significantly improve the text extraction from images.

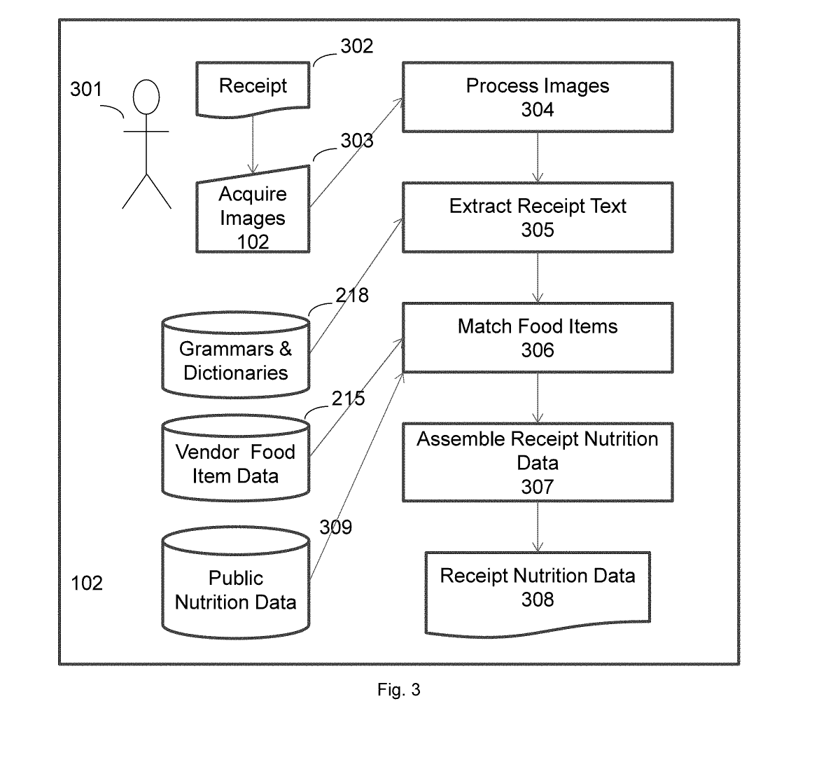

FIG. 3 shows yet another embodiment of this invention detailing the processing of a receipt to generate per-item nutrition information in 103.

Generally speaking, the embodiment described in FIG. 3 teaches how to raise success rates of automatic text extraction in challenging situations to levels that support consumer applications of all types, and specifically allows accurate, automatic extraction of food item data from images of receipts, on the path to generate a person's nutrition intake report.

Text extraction via images is typically carried out with image processing tools such as optical character recognition (OCR). As a mature developed tool, OCR meets expectations in cases where the image is a PDF of a word document, or a high resolution tiff file of a printed check. In the first case, since the image is computer-generated from ground truth, the quality is exceptionally high. In the second case, the domain is exceedingly narrow, i.e. dollar amounts. However, those skilled in the art would recognize that OCR begins to fail quickly in more challenging domains for real world receipt images as described below.

As described in the Background Section, consumer-friendly extraction of a household's nutrition intake data as represented in the household's grocery receipts requires automatic processing of those grocery receipts. Receipts are often crushed up and shoved into a pocket or a grocery bag. Some stores such as Costco require their employees to score the receipt with a pen or a fingernail to generate a line or other mark through the receipt. Receipts can be torn, taped, printed while the ink was running out, faded, double-printed, skewed on the paper, and so on. Furthermore, when the household member takes an image of the receipt, the receipt is often not smoothed out leading to multiple feasible rectangular frames of reference in one image, which then create offsets in the extraction between food items and their corresponding data such as price, UPC or weight. The image lighting is often poor leading to shadows, overexposure, or underexposure in the image data. Finally, the domain for grocery receipts is significantly broader than just the dollar amounts present on a check. Not only are there tens of thousands of different food items in any given market, but every specific grocer has their own shorthand for denoting the food items they carry, requiring a comprehensive dictionary that can run in the millions of terms for a given market.

All told, these conditions represent an extreme worst-case situation for today's OCR technology, presenting a challenge that the typical application of OCR simply is not up to. Providing accurate nutrition intake information for consumers would greatly benefit from accuracies of at least 95% (maybe 1 or 2 errors per receipt). Some of the best OCR available today, for example, the Google Vision API typically achieves accuracies between 40% to 80%, depending on the receipt, averaging about 60% accuracy. Anyone skilled in the art would recognize that such a gap in accuracy is qualitative, not quantitative. In other words, OCR simply does not work in this challenging environment. The embodiment in FIG. 3 demonstrates how to overcome this significant obstacle.

FIG. 3 begins with a household member 301 with access to a household receipt 302 from, for example, a grocery store where the household member bought groceries. This embodiment asks the household member to take an image of the receipt 303, without any need of special preparation like taping it down, or making it flat. In 303 while the household member believes they are taking one image, the system is actually taking multiple images. The two images with largest difference in frame of reference and lighting are preserved and sent to image processing in 304.

Image processing in 304 can be performed on the local device if the household member's device is powerful enough, or can be performed upstream on the cloud. The two images are pushed through a series of transformation to generate upwards of a dozen processed images that are fed to text extraction in 305. The processed images include lower resolution versions of the original images, black and white filter versions, cropped versions and so on. Each different processing technique helps avoid one or more of the challenging artifacts mentioned above, but no processing technique addresses all. The key element of this embodiment is to perform OCR on all different processed images, and combine the results to provide a workable text extraction result for this problem. There are many image processing techniques possible to apply in these fields. The specific details do not affect the scope of this invention.

Supervised text extraction in 305 is carried out on each processed image fed to it from 304 to recover the purchased food items therein. The text extraction in this embodiment is OCR supervised with a set of previously generated grammars and dictionaries 218. The key to which grammar and dictionary to use is the vendor represented on the receipt. Usually receipts carry vendor logos, names, addresses, phone numbers and store numbers. These multiple independent pieces of information are used to identify which vendor grammar and dictionary from 218 to use in 305. Grammars are used to adjust recognition weight/probabilities when parsing the image. For example: if grammar 218 tells a line item for Stop&Shop is <UPC, name, price>, then “Firm Tofu” shall be followed by price according to grammar. Dictionaries are used to tailor word parsing weight/probabilities, decreasing transcription errors. For example, unsupervised OCR gives “Firm Rofu”, while the parsing process supervised by the vendor dictionary increases the recognition probability for “Firm Tofu”.

Text extraction in 305 combines the dictionary and grammar-enabled OCR output for each of the dozen or so processed images, and sends the finalized outputs on to the matching process in 306. The finalized outputs include two categories. The first category includes commodity name/description and amount. The second category is metadata including time, location, store, etc. The output is generated using a mixture of experts approach. There are many approaches to combining the OCR outputs for each processed image, from strict voting to much more complicated approaches. The specific details are not pertinent to this invention. In this embodiment, first any clearly broken output are eliminated, like some lower resolution images completely illegible. The finalized output is a weighted vote of the remaining experts, where each expert is given more or less weight based on which artifacts are present in the image and how the processing per expert tends to accent or eliminate said artifacts.

The supervised extraction and processing of multiple diverse images as described in blocks 303, 304 and 305 are keys to the invention in this embodiment. By providing multiple different views of the same receipt, the impact of the challenging artifacts described above are reduced far enough that the extracted text is highly accurate. Again, anyone skilled in the art would recognize that being able to present finalized output with less than one error per receipt makes a qualitative difference in this domain, eliminating a key obstacle to the overall feasibility of providing nutrition intake to consumers.

The finalized output is passed to the matching process in 306, wherein each line item in the finalized output is searched for against the specific vendor DB identified in the receipt and stored in 215. The corresponding nutrition panel data for each food item is returned. Alternative routes are provided in case the vendor or item is not found in 215. For receipts from some fast food restaurants, such as Subways, McDonald's, the vendors do disclose nutrition information per food item, which is used directly. Second, public nutrition databases 309 are used as a backup. The USDA provides a database for total nutrition facts based on UPC code (Ref: USDA National Nutrient Database for Standard Reference) or description of food in general category, vegetable name, etc. (Ref: USDA Branded Food Products Database, USDA food composition database). Third, for cases where there is not an exact match, there are several possibilities, from flagging the entry for the consumer's attention, to selecting a close match for the item, to pushing the request out through the sampling process in 216. This embodiment does a combination of all of above.

The matching process 306 passes the results of matching against the vendor DBs in 215 to the assembly process in 307. This process simply converts the match outputs into receipt nutrition data 308, which is a collection of tuples of <date, location, food item, amount, total nutrition fact panel>.

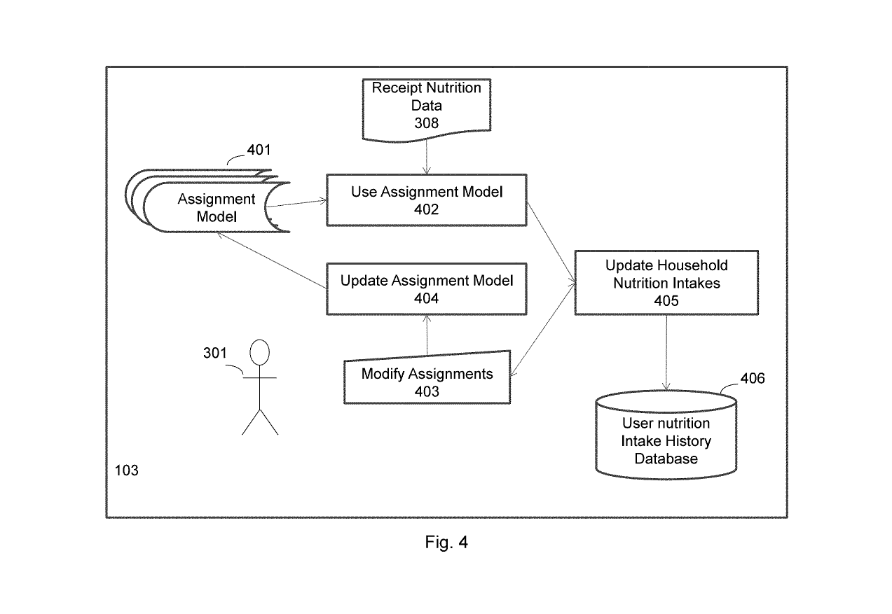

FIG. 4 shows yet another embodiment of this invention in 104, detailing the creation of preliminary nutrition intake data for each household member from the receipt nutrition data generated from 103.

The key to comprehend the embodiment described in FIG. 4 is to understand the use of the food assignment models in 401. The overall goal of the preferred embodiments is to make nutrition intake tracking a palatable activity for as many people as possible—for every household member to engage in the activity, not just for one household member.

An assignment model 401 for a household is used to indicate which person typically consumes what percent of which food item. Every household member prefers it when the default assignments are as accurate as possible so they do not have to provide manual inputs for most items. On the other hand, each member will also want complete control over his/her own data. For example, household member Mom goes shopping and buys Doritos, potatoes and noodles for a household composed of three members: Mom, Dad and Son. If Mom creates an assignment she likes, it would not be acceptable for her to find out a few days later that Son has modified it, thereby changing her nutrition intake. For example, the default assignment in the food assignment model provides the following distribution of purchased food among household family members:

TABLE 1
Proposed food consumption assignment among family members
of a household by a first family member.

| Family | Food | | |
|---|---|---|---|
| member | Doritos | Potatoes | Noodles |
| Mom | 0% | 33% | 17% |
| Dad | 100% | 33% | 33% |
| Son | 0% | 33% | 50% |

At the beginning, Mom is happy with the assignment, and moves on with her day. Two days later, household member Son is reviewing the default assignment, and changes it to:

TABLE 2
Modified food distribution model among family members of a
household by a second family member.

| Family | Food | | |
|---|---|---|---|
| member | Doritos | Potatoes | Noodles |
| Mom | 50% | 10% | 20% |
| Dad | 50% | 10% | 60% |
| Son | 0% | 80% | 20% |

In this example, the assignments put in place by Mom and Son conflict. What is the right way to proceed? In this embodiment, for this household, 3 separate assignment models are maintained and updated, one for each household member. This allows the app to present a worldview of assignments that is consistent with the manual revisions made by each household member. Each model assigns consumption percentages to each food item for each household member. Each model and assignment informs the other two, but no human manual revisions for one model will ever be overridden by default or manual entries for a different model. In this way, the assignment model for Mom may disagree with the assignment model for Son on some receipts, but in return, both parties can fully control the inputs to their own nutrition intake summaries.

The receipt nutrition data in 308 are input to the use assignment process in 402. The use assignment process accesses the assignment model 401 for the household member 301 that is currently using the app and has manually acquired images 303 of the receipt (the first assignment model). The assignment models for other family members are also accessed in the background. Each food item from 308 is fed to the first assignment model, resulting in a table of assignment percentages per food item, per family member. Similarly, in the background, an additional table of assignments is created using the possibly different assignment model for each household member.

The assignment tables with consumption percentages are passed to the update household intakes process 405. This process reads the current user nutrition intake database 406 and updates nutrition intakes given the information in each assignment table passed to it. Note that each household member has his/her own view of the household nutrition intake data. As described above, this separate view is critical to the overall utility of the preferred embodiments. In addition to the reasons described above, privacy is a strong motivator for separate world-views. Many food receipts will not be household-wide, but rather specific to an individual, and may include lunches at work, roadside coffee, snacks, restaurant receipts and so on. The separate world views of household nutrition intakes for each household member means that these several worldviews are maintained in the database 406 and updated separately by the “update nutrition intake” process 405, guided by information of purchase time passed through metadata in 102.

Part of the “update nutrition intake” process is to give the household member 301 an opportunity to review the current assignment table produced by 402, and to modify it manually in 403. The assignment models 401 need to be good enough that this step is rarely used, but when the user does make a change, the data is quite valuable. If the manual changes differ from an earlier assignment made by a second household member, the first household member will receive a notice or message to show how and where they differ. If the manual changes differ from a very highly confident learned result, the first household member will receive a notice or message to show how and why.

The assignment models 401 are learned over time in 404. The form of the actual model itself is largely an irrelevant detail for this embodiment, since many different types of models all provide similar functionality. This embodiment represents and learns models with standard machine learning techniques such as decision trees.

Food items are characterized by hundreds of features describing specific traits of the food, such as flavor, nutrition aspects, advertising, textures and so on. Decision trees are learned over these features, as is the norm. Assignment models are initialized with default models representing general population patterns. For example, the snack brand Lunchables tends to be eaten by children, expensive beer by middle-aged men and plain yogurt by older women.

The update process 404 starts with generated training data that reflects the general population patterns. The update process then utilizes the manual revisions made by a household member 301 in 403 as further training data to update the models in 401. These updates are specific to individual household members, and so the training samples are treated with much greater weight for the household than for the general population. The manual assignments made by one household member for a given receipt nutrition data 308 are used as highly weighted training data for all assignment models for all household members. In this way, if a first member has made a few manual assignments for the household, the default assignment models for a second household member should be reasonably accurate before the second household member has done anything manually. If, however, a second household member changes an assignment in 403, those specific modifications are applied in 402 to the household's worldviews. For the first household member this is accomplished in a manner consistent with the first household member's previous revisions. This overwrite protection is applied at the food item level, not the feature level.

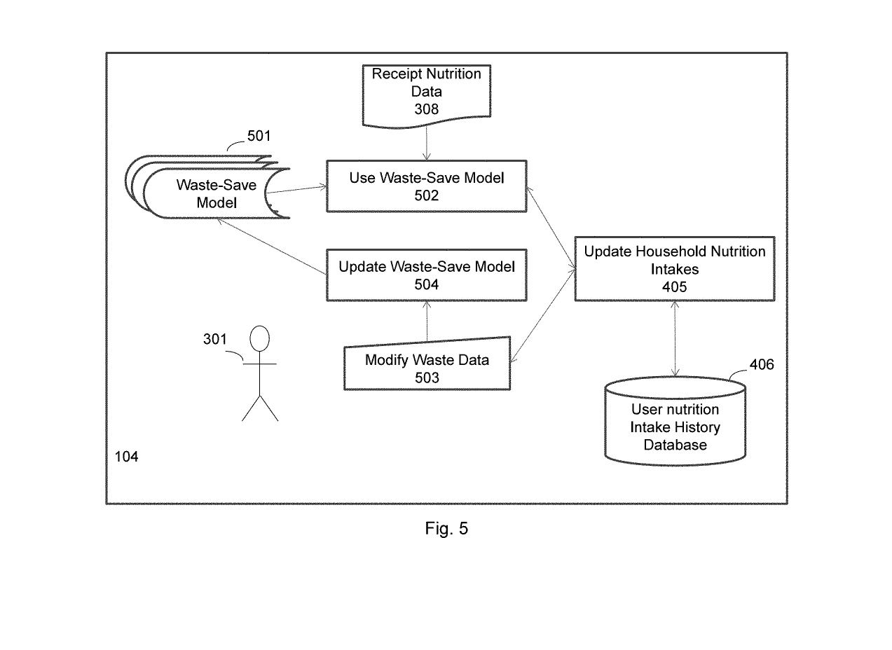

FIG. 5 shows yet another embodiment of this invention in 105, teaching how the portion of the user nutrition intake database 406 created from a receipt nutrition data 308 is modified to reflect real consumption over time, including properly accounting for food eventually thrown away rather than consumed.

When building an accurate image of nutrition intake per household member, one cannot rely on how much food was purchased or directly consumed through some act of hospitality. For example, according to the EPA (https://www.epa.gov/recycle/reducing-wasted-food-home), in 2013 North American households threw away over 35 million tons of food.

Additionally, and obviously, most food items bought on a grocery shopping trip are not consumed on the day of the purchase. Some items may be consumed within a day or two, while other items may be steadily used for 6 months or longer. For example, when people buy a gallon of milk, chances are high that it is consumed within a few days. This is especially true if the purchase behavior pattern shows an average of, for example, 3 gallons bought per week. On the other hand, when people buy a five-pound bag of flour, chances are high that it is consumed over a significantly longer period.

Determining how much food is thrown away, versus stored, versus consumed within a period of time is a significant barrier to assembling an accurate image of household nutrition intakes. The embodiment in FIG. 5 shows show to overcome that barrier.

The key to useful waste-save models per household 501 is to relate typical statistics for the following: shelf life per food type, average food storage space per household in a given market, and typical household food waste percentages per food type. Then customize this market-model for individual households by further relating data on household purchase frequency per food type, and specific feedback from a household member for fine-tuned adjustments. Optionally, market defaults for, say, cubic feet of refrigeration can be replaced by household-specific metadata acquired during the app setup.

The market-wide waste-save model in 501 has the following information for every food item in the vendor food databases 215: <food item, food type, eat-by day, storage type, storage volume>. The food type in this embodiment is the USDA 11 group classification, although many other categorizations would work well. The eat-by day field in the tuple above is the number of days before the eat-by date expires, and basically acts as a proxy for shelf life. Storage type is freezer, refrigerator, or dry space.

The household-specific waste-save model in 501 has the following information for every food item that has shown up in the user nutrition intake database 406: <food item, current estimated consumption rate, historical data>. The current estimated consumption rate is the expected number of days it would take the household to consume the food item. The historical data is a record of previous purchases of the food item, going back, for example, for a period of a year, as well as a record of dates on which some percent of the item was thrown away.

The use waste-save model process in 502 reads the receipt nutrition data 308, utilizes the household and market-wide waste save models in 501, and computes both a food waste estimate for previously purchased food items, and a consumption timeframe for the food items showing up in 308. This information is passed to the “update household nutrition intake” process in 405.

The computation done in 502 to construct waste estimates and consumption timeframe proceeds as follows. The starting point is the market-wide waste-save model described above, and an initial household specific model, along with an initial estimate of the household's storage capacity. These estimates may be as carefully broken down as desired. In this embodiment, the storage estimates for cubic feet of freezer space, refrigerator space and dry storage space are taken from averages of the interested market. Initially each type of storage is assumed 50% full in default. In this embodiment, the household's initial waste save model is a mapping from food item to one of the 11 USDA food categories, and each food category has a default consumption timeframe estimate based on the size of the household where the household member 301 belongs.

The initial state of the computation in 502 described above is modified once the receipt data enters the system via 308. The computation described below is after the system has been run and updated for a while. The initial assumptions are not relevant to this embodiment, and in fact many different startup procedures would work well.

The receipt data in 308 is the result of a new purchase activity. Naturally, the food bought in this transaction will wind up in three possible places: household consumption, storage, and/or waste. The computation proceeds as:
1. Update the historical data in the household model in 501 by adding a date and quantity for each food item in 308;
2. Update the estimated consumption timeframe per food item in 308 by taking a recency-weighted average over the historical data of the days between purchase, normalized to a purchase quantity of one;
3. Update the freezer, refrigerator and dry storage to account for consumption, allowing for repackaging, so for example open storage space will increase here;
4. Allocate new food items as per 308 to storage. In this embodiment, the following storage overflows are allowed: zero days for freezer, 1 day for refrigerator, and 4 days for dry storage;
5. If there is no room left in the appropriate storage area after the overflow has been accounted for, then waste and modified consumption rates make up the difference.

In the last step #5 above, there are many reasonable ways to split the difference between waste and modified consumption rates. In this embodiment, the choice of where to allocate the excess is made in the following procedure: For each storage type (i.e. freezer, refrigerator, dry), identify the possible thrown away items. Beginning with all historical food items in the household waste-save model 501 that are still taking up storage space, remove from the waste list anything with more than a predefined time length, for example, ten eat-by days remaining. The rest is food items that may be nearing the end of their shelf life. Further remove from the waste list any item whose typical purchase frequency is high enough that the chances are high the item will be consumed within the remaining eat-by days. For the food items left on the waste list, weight them according to historical data in the household model 501 such that items that have been disposed of more often in the past have a higher probability weight.

At this point, if the proposed waste list falls within the household norm, stop, and move on to the manual inspection phase in 503. Otherwise, consider modifying consumption frequencies. As with the possible waste list above, construct a possible consumption frequency adjustment list based on the items taking up storage space. Remove from this list items with a high enough purchase frequency to be treated as a household staple. Weight the remaining items such that those with the lowest consumption frequency have the highest weight. Lastly, adjust the consumption frequencies up to a max of five percent to account for the excessive overflow in storage.

Once the household waste-save model has been used in 502, control passes to updating the household nutrition intake in 405. 405 attaches timeframes to support nutrition reports in 106. The waste portion of the data is used to modify the nutrition intake data in 406 for each household member based on the assignment percentages per food item developed in FIG. 4. The resulting information is used to modify the user nutrition intake databases in 406. The information is also presented to the household member 301 currently using the app. The household member may be presented with the food thrown away and asked to make adjustments. Depending on the amount of excess, the household member may also be prompted with questions like “are you throwing a party”, or “did you have guests over last week”, or “Did your storage space increase”? The household member may modify the waste data being presented manually in 503, at which point the household waste-save model 501 is updated in process 504, and the use waste-save model 502 is re-invoked.

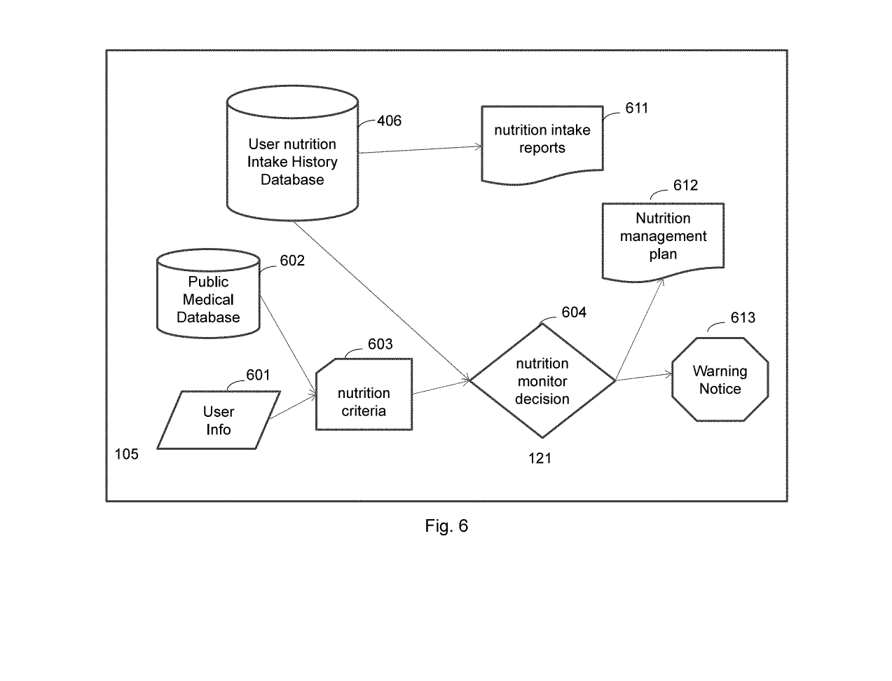

After the nutrition intake history database 406 is finalized, the total nutrition intake for a household and its members is analyzed for reporting. FIG. 6 describes yet another embodiment of this invention, detailing the production of nutrition intake report 106. For the convenience and ease of understanding for the user, nutrition reports are presented in several different ways. The reports provide different views of nutrition history, warning notices for immediate attention when intakes appear out of line with standard criteria, and nutrition management plans.

To help produce management plans, nutrition check point results and stress test reports, user information 601 including individual age, gender, family size, marital status, income, medical condition, etc. is utilized to generate standard nutrition criteria 603 based on public medical databases 602. Using these criteria to evaluate the user nutrition intake history in 406, a risk-informed decision 604 is made to monitor the nutrition intake. Two products are created from this risk analysis decision. The first one is nutrition management plan 612. It provides customized guidance on what kind of steps should be taken to keep a balanced diet and reach healthy nutrition goals. It will also point out which impulse purchase transactions do not help to contribute to healthy nutrition intake. Where there are concerns on overall nutrition intake, product warning notices 613 are issued to attract the attention of the user, and motivate the user to make (better) educated decisions in food selection and smart grocery shopping.

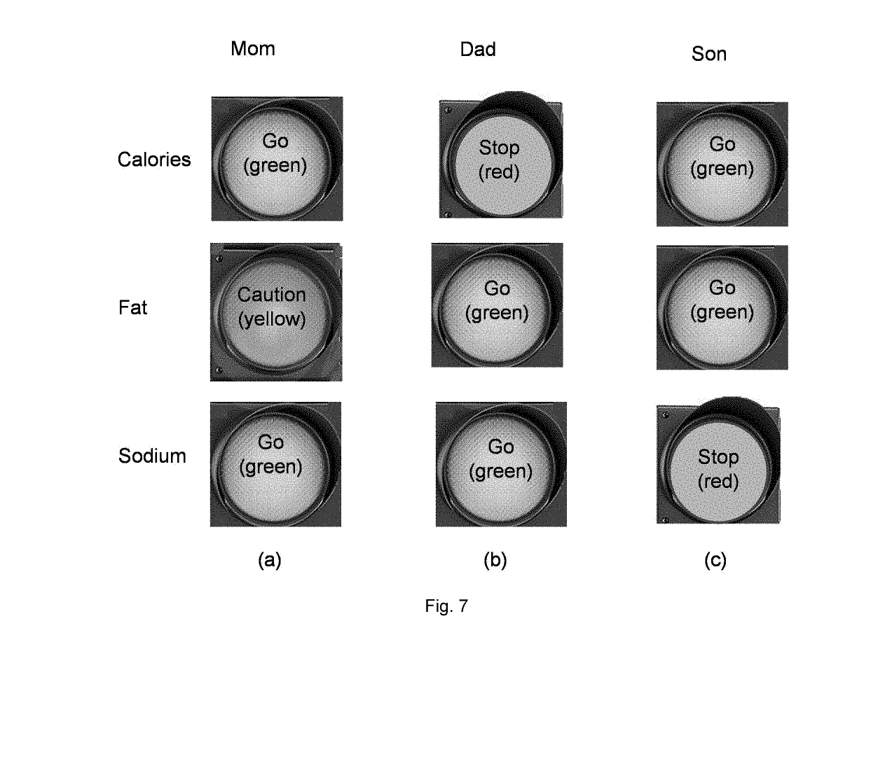

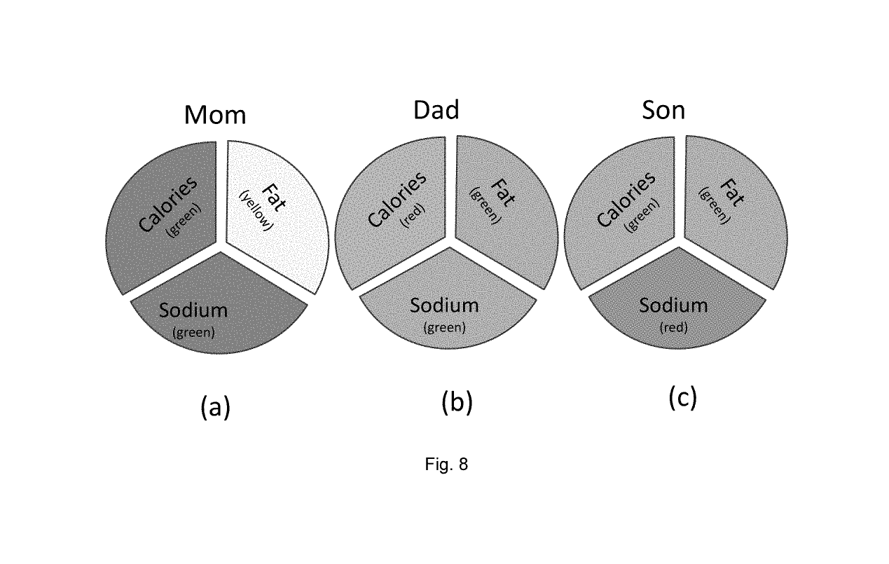

Some exemplary nutrition intake reports are presented in different formats. FIG. 7 and FIG. 8 illustrates a typical summary traffic signal chart and pie chart for a family nutrition intake history analysis with risk based suggestions for (a) mom, (b) dad and (c) son. The nutrition of interest in this chart is summarized into three categories: calories, fat, and sodium. More categories may appear in these charts including without limitation various breakdowns of fat (such as unsaturated fat), calcium, Vitamin D and potassium. The categories are colored based on the relationship of intake amount to the recommended nutrition intake range. Green represents intake amounts within the recommended range. Yellow is in the warning range. Red indicates critically out of range values, indicating that immediate diet change or medical actions are needed. The immediate conclusion in FIG. 7 and FIG. 8 is: Mom's intake of fat is at the warning level, whereas Dad's intake of calories and Son's salt intakes are critically high. Further details are provided in an itemized report for the users' further reading and exploration.

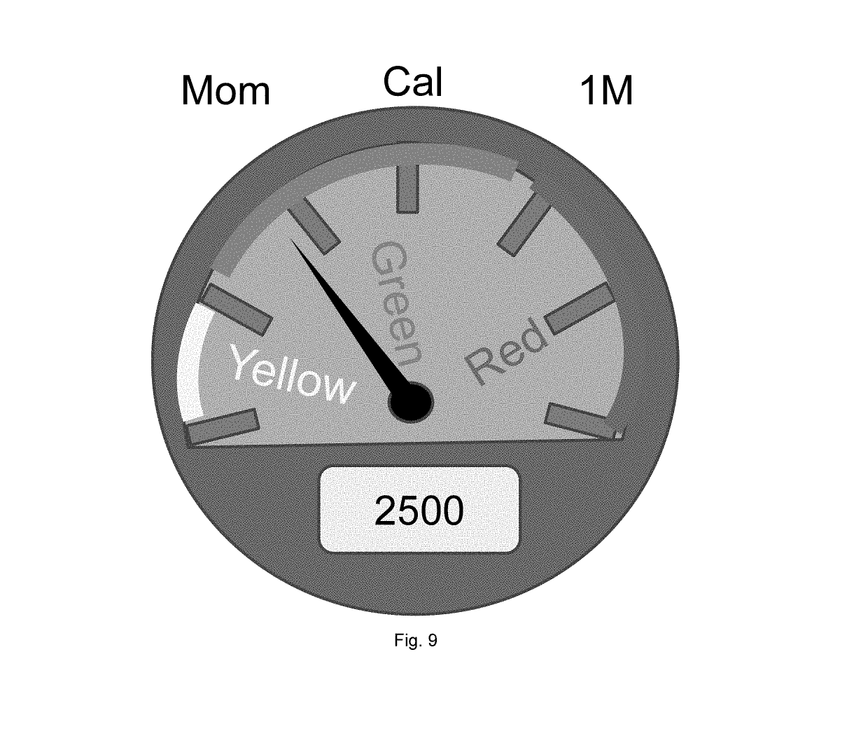

Individual nutrition intake summary reports are also shown in dashboard speedometer chart format such as in FIG. 9, which is represents Mom's caloric intake in the past month. Her averaged intake in selected time range is 2500 Cal/day, with the dial in the acceptable green range. This kind of figure provides more detail than FIGS. 7 and 8, showing the position of dial of individual intake rate related to colored ranges. The color ranges are defined as green for ideal consumption rate, yellow for cautious intake rate and red for risky one. This provides more visible and quantitative representation of how serious the nutrition intake rate is, comparing with the criteria provided by public data or physician recommendation.

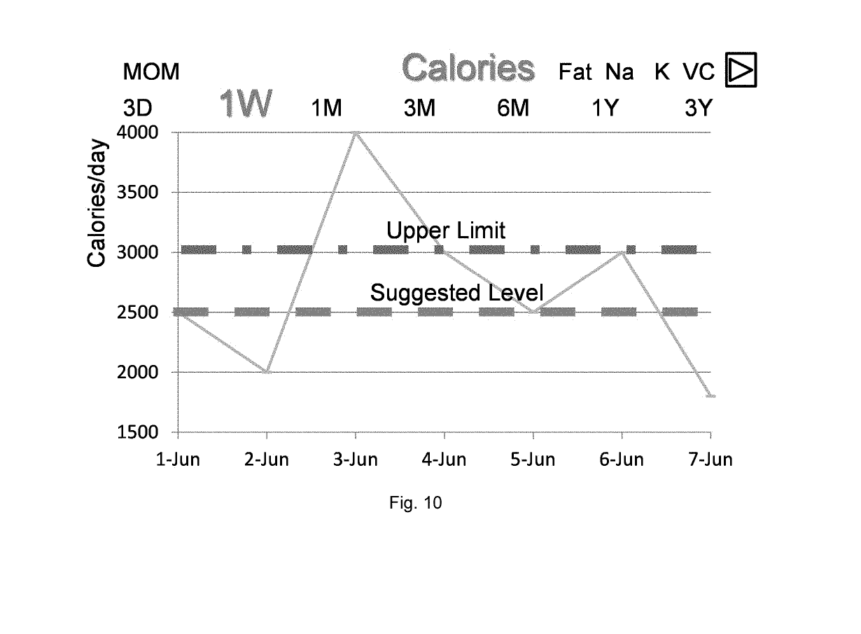

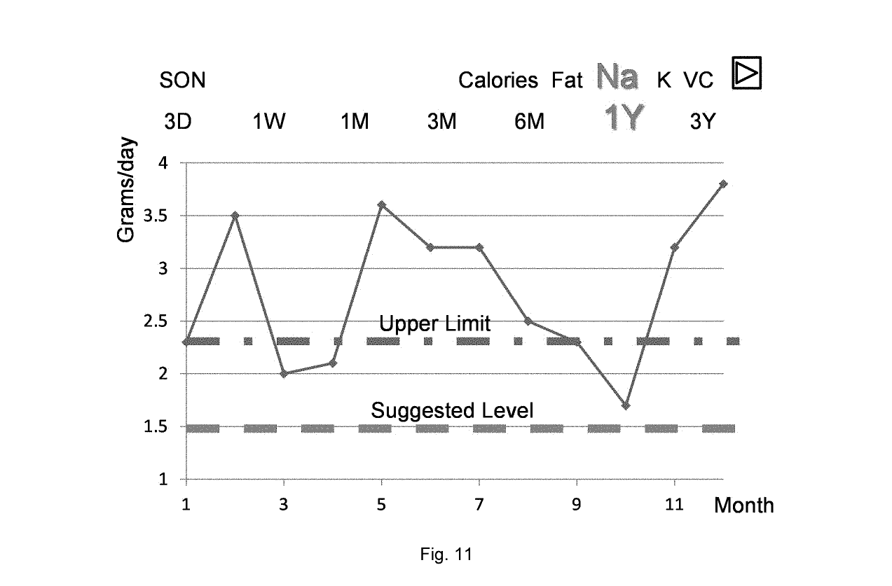

Individual nutrition intake histories are illustrated in mark or line plot figure format. FIGS. 10 and 11 show the intake history of the nutrient of choice during a selected time range for any individual. FIG. 10 illustrates Mom's caloric intake history within 1 week. FIG. 11 illustrates Son's sodium intake history within 1 month. The suggested dose based on standard criteria for the individual is shown as a green dashed line while upper limit does is in red. The readout for Mom's caloric intake shows that although Mom's average intake is within a healthy limit (concluded from FIG. 7), she occasionally takes more than necessary. Combining this information with meal intake pattern recognition, the detailed history may reveal more hidden patterns and provide useful diet suggestions for household members.

Furthermore, the details of individual nutrition intake history are presented in multiple table format. They are activated which the corresponding summary nutrition intake summary plots are clicked or highlighted. For example, Table 4 appears when the pie chart of Mom nutrient intake summary in FIG. 8 is clicked. It demonstrates the detail of nutrition intake rate and suggestion.

TABLE 4
Exemplary detailed list of nutrition intake rate of Mom
during a month period.

| | Mar. 1, 2016-Mar. 31, 2016 | | | |
|---|---|---|---|---|
| Mom | consumption | reference | | |
| nutrient | daily rate | daily intake | | suggestion |
| Carolie | 2500 | 2400 | | [symbol] |
| Fat | 80 g | 44-78 | g | ↓ |
| Sodium | 2.0 g | 2.3 | g | [symbol] |
| potassium | 4.8 g | 4.7 | g | [symbol] |
| Calcium | 1.2 g | 1000 | mg | [symbol] |
| Iron | NA | 18 | mg | NA |
| Vitamin A | NA | 700 | mcg | NA |
| Vitamin B6 | NA | 1.3 | mg | NA |
| Vitamin B12 | NA | 2.4 | mcg | NA |
| Vitamin C | 90 mg | 75 | mg | [symbol] |
| Vitamin D | NA | 15 | mcg | NA |
| Vitamin E | NA | 15 | mg | NA |
| thiamin | NA | 1.1 | mg | NA |
| Riboflavin | NA | 1.1 | mg | NA |
| Niacin | NA | 14 | mg | NA |
| Folic acid | NA | 400 | mcg | NA |

Table 4 provides the detailed information of consumption rate of multiple nutrients for Mom in a one-month period. The nutrient requires attention, fat, is highlight with yellow, categorized as cautious. Suggestions are provided in this table: cut down fat intake, while keeping the same intake rate for all the other nutrients. Most of the intake rate for minerals and vitamins are unknown. The user has an option to opt out the warning signal due to the lack of data, or updated criteria provided by new source or physician recommendation.

Further detail about one nutrition consumption based on purchase history will be detailed in another kind of table format. This function will enable the user to identify how much food items purchased or consumed contribute to the nutrition interested to the user. For example, Table 5 appears when the row of “fat” in Table 4 is clicked to show the related purchased activity to the consumption of fat for Mom.

TABLE 5
Exemplary list of purchase activities related to intake of fat
by Mom during one-month period.

| Mom | Fat | | | |
|---|---|---|---|---|
| Purchased | purchase | Mar. 1, 2016-Apr. 1, 2016 | | |
| item | date | vendor | assignment | amount |
| chips | Feb. 27, 2016 | Grocer1 | 25% | 20 g |
| chips | Mar. 12, 2016 | Grocer1 | 25% | 30 g |
| chips | Mar. 28, 2016 | Grocer2 | 25% | 5 g |
| milk | Feb. 27, 2016 | Grocer1 | 20% | 25 g |
| milk | Mar. 12, 2016 | Grocer1 | 20% | 32 g |
| milk | Mar. 28, 2016 | Grocer2 | 20% | 6 g |
| dressing | Feb. 25, 2016 | Grocer1 | 30% | 62.4 g |
| dressing | Mar. 15, 2016 | Grocer3 | 30% | 62.4 g |
| hamburg | Mar. 18, 2016 | Deli1 | 100% | 15 g |
| cooking oil | Feb. 15, 2016 | Grocer4 | 33% | 100 g |
| . . . | . . . | . . . | . . . | . . . |
| total | | | | 2480 g |

This table provides all the purchase information, assignment ratio, and consumption amount related to fat intake by mom in the one-month period. Purchase activity pattern is recognized in this detailed table. Risky purchase food items and pattern are identified. Furthermore, customized purchase recommendation is provided from dimension reduction and risk based decision making.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. While the embodiments discussed herein may appear to include some limitations as to the presentation of the information units, in terms of the format and arrangement, the invention has applicability well beyond such embodiment, which can be appreciated by those skilled in the art. Accordingly, the scope of the present invention is defined by the appended claims rather than the forgoing description of embodiments.

We claim:

1. A method for computing a household member's nutrition intake comprising:
acquiring images of the household member's household grocery receipts;
processing the images to match purchased food therein against a reconstructed vendor database; and
computing the household member's nutrition intake for a period of time.

2. The method as recited in claim 1, wherein a summarized and detailed presentation of the household member's nutrition intake for the period of time is provided.

3. The method as recited in claim 1, wherein the reconstructed vendor database is created by assembling completed snippets extracted from at least one crowdsourced marketplace.

4. The method as recited in claim 1, wherein a food assignment model is used when computing the household member's nutrition intake in order to help allocate the household's consumption to the household's members.

5. The method as recited in claim 1, wherein a food waste-save model is used when computing the household member's nutrition intake in order to help allocate the household's grocery purchases between consumption, storage and waste.

6. The method as recited in claim 2, wherein the summarized and detailed presentation is provided in a traffic signal format, and traffic light colors provide a direct indication of whether the intake level of a specified nutrient during the period of time is within a healthy range, needs attention or requires immediate action.

7. The method as recited in claim 2, wherein the summarized and detailed presentation is provided in a speedometer format, and speedometer colors provide a direct indication of whether the intake of a specified nutrient during the period of time falls within a healthy range, needs attention or requires immediate action.

8. The method recited in claim 2, wherein the summarized and detailed presentation is provided in a mark line plot format. The investigated nutrient intake during the period of time is presented in a plot.

9. The method recited in claim 2, wherein the summarized and detailed presentation is provided in a table format. A purchase activity for the household member related to a specified nutrient during the period of time are listed in a table.

10. A method for text extraction from one image of a receipt acquired by a household member comprising:
processing the one image with a first processing technique and a second processing technique that differs from the first processing technique, to generate a first processed image and a second processed image, wherein the first and second processed images are different from each other;
performing text extraction on the first processed image and the second processed image; and
combining the text extraction on the first processed image and the second processed image to provide a corrected text extraction for the one image.

11. The method as recited in claim 10, wherein the text extraction is a supervised form of optical character recognition.

12. The method as recited in claim 10, wherein the processing techniques are chosen to maximize differences in the text extraction performed on the resulting first processed image and the second processed image.

13. The method as recited in claim 10, further comprising:
capturing more than one images of the receipt when the one image of a receipt is acquired by the household member;
selecting a chosen image, different to the one image, from the more than one images of the receipt;
additionally processing the chosen image in the same manner as the one image to generate a third and a fourth processed image;
additionally performing text extraction on the third and the fourth processed image; and
combining the text extraction on the third and the fourth processed image with the text extraction on the first and the second processed image to provide a corrected text extraction.

14. The method as recited in claim 11, wherein the supervision is guided by the grammar and dictionary data for vendor and other public database. Extracted texts are used to feedback and weigh the reconstructed vendor database.

15. A method for reconstructing an undisclosed database from partial and incorrect views comprising:
posting snippet jobs for the undisclosed database in response to a relative sampling rate to a crowdsourced marketplace, with the expectation that a portion of the jobs will be accepted by a worker who works on the portion of the jobs to create completed snippets;
assembling the completed snippets in response to a worker accuracy model; and
updating the undisclosed database.

16. The method as recited in claim 15, wherein the undisclosed database is a vendor database with information on purchasable food items.

17. The method as recited in claim 15, wherein the worker accuracy model is used to weight conflicting snippets for the assembly process.

18. The method as recited in claim 15, wherein a new item percentage is used to estimate how much of the undisclosed database has been observed, which is then used to adjust the relative sampling rate for the undisclosed database with respect to a second undisclosed database.

19. A method for creating and maintaining multiple worldviews of a food assignment model for a household comprising:
storing a first food assignment model with food allocations consistent with a first household member's manual revisions, and a second food assignment model with food allocations consistent with a second household member's manual revisions;
presenting household food assignments to the first and the second household members as potentially conflicting consumption percentages for each food item represented in a grocery receipt; and
updating the first food assignment model responsive to manual revisions to the food consumption percentages made by the second household member, while ensuring that the first food assignment model presents food consumption percentages consistent with all manual revisions made by the first household member.

20. The method as recited in claim 19, wherein the first and second food assignment models are updated with machine learning techniques.

21. The method as recited in claim 19, wherein the manual revisions made by the second household member are appended to training data used to construct household-specific food assignment models.

22. The method as recited in claim 19, wherein the manual revisions made by the second household member for a first food item changes food consumption percentages presented by the first and second food assignment models for food items purchased at a later date, which are different than the first food item.

23. A method to create a food waste-save model for a household, comprising:
building a market-wide waste-save model by relating statistics for shelf-life per food type, to average household food storage space in a given market, to typical household food waste rates per food type; and
customizing the market-wide waste-save model to the household by using household purchase frequency per food type.

24. The method as recited in claim 23, wherein household food storage space is composed of dry storage, frozen storage and refrigerated storage space.

25. The method as recited in claim 23, wherein the household purchase frequency per food type is used together with the household waste-save model, and a food assignment model to further compute a consumption timeframe per food item for each household member.

26. The method as recited in claim 23, wherein the household waste-save model is updated after a grocery shopping receipt is acquired, by first allocating all purchased food items in the grocery receipt to household storage, then allocating the remaining food items by adjusting household food consumption rates per food type, and in response to household food waste rates.
